(19) United States
(12) Patent Application Publication
(10) Pub. No.: US 2025/0138191 A1
(43) Pub. Date: May 1, 2025

(54) Sensor apparatus for detecting deposits on a windowpane

(71) Applicant: HELLA GmbH & Co. KGaA, Lippstadt (DE)

(72) Inventors: Thomas Niemann, Delmenhorst (DE); Viktor Gerliz, Oldenburg (DE)

(21) Appl. No.: 18/934,698

(22) Filed: Nov. 1, 2024

(30) Foreign Application Priority Data
Nov. 1, 2023 (DE) 10 2023 130 197.7

(51) Int. Cl. G01S 17/88

(52) U.S. Cl. CPC G01S 17/88

(57) ABSTRACT

In a sensor apparatus for detecting deposits, in particular water deposits such as moisture deposits and/or ice deposits on a windowpane, in particular on the inside of a motor vehicle window, with a radiation emitter for irradiating the windowpane and with a radiation receiver for detecting the radiation intensity of the radiation reflected back from the windowpane, and wherein at least one optical body with at least one radiation guidance element is assigned to the radiation emitter and/or the radiation receiver, it is provided as essential to the invention that the radiation guidance element has at least two segments, that each segment has at least one refractive surface, and that the refractive surfaces are arranged facing the radiation emitter and/or the radiation receiver.

The invention relates to a sensor apparatus for detecting deposits, in particular water deposits such as moisture deposits and/or ice deposits on a windowpane, in particular on the inside of a motor vehicle window, with a radiation emitter for irradiating the windowpane and with a radiation receiver for detecting the radiation intensity of the radiation reflected back from the windowpane, wherein the radiation receiver is designed to detect the scattered radiation intensity of the radiation scattered on the windowpane, and wherein at least one optical body with at least one radiation guidance element is assigned to the radiation emitter and/or the radiation receiver.

The detection of deposits such as dirt or water deposits, for example condensation, ice deposits or even frost formation, can be extremely important for the safe control of a motor vehicle. Not only can the formation of deposits impair the vehicle driver's view, it can also cause interfere with the function of a display projected onto the inside of the windowpane, that is to say the function of a “head-up display”. Consequently, the driver is unable to see the information that is important for him properly, for example the fuel gauge, the charge state of the battery, the traffic sign recognition, the current vehicle speed and the like. A windscreen that is obscured by ice, smeared with frost, foggy with condensation or dirty leads to a distortion of the projected information. As a consequence, the driver may not be able to see information he needs in order to use the road safely, or he may misinterpret it. If frost, ice or condensation forms on the inside of the windscreen, the driver must be informed accordingly, or the actuation of the head-up display must be adapted. In order to do this, early detection of said deposits is imperative. Sensor apparatuses for detecting condensation states are known from DE 10 2006 039 034 A1, for example.

Since apparatuses of such kind already in use in an enormous number of motor vehicles, it is necessary to design a corresponding sensor apparatus that can be used in an enormous number of vehicle types. Vehicle types may be classified in particular according to the setting angle of the windscreen relative to the sensor apparatus and the possible distance from the windscreen at which the sensor apparatus may be arranged. In particular, in this context it is critically important to achieve a sufficient signal strength, that is to say a sufficient radiation intensity for different setting angles and distances.

The object underlying the invention is to suggest an apparatus for detecting deposits on a windowpane, with which an early detection of deposits such as moisture deposits and/or ice deposition on a windowpane is assured, and with which a sufficient signal strength can be achieved in various installation situations in a motor vehicle.

This object is solved with a method having the features of claim 1 and with a motor vehicle having the features of claim 19.

In a sensor apparatus for detecting deposits, in particular water deposits such as moisture deposits and/or ice deposits on a windowpane, in particular on the inside of a motor vehicle window, with a radiation emitter for irradiating the windowpane and with a radiation receiver for detecting the radiation intensity of the radiation reflected back from the windowpane, and wherein at least one optical body with at least one radiation guidance element is assigned to the radiation emitter and/or the radiation receiver, it is provided as essential to the invention that the radiation guidance element has at least two segments, that each has at least one refractive surface, and the refractive surfaces are arranged to face the radiation emitter and/or the radiation receiver.

The windowpane, in particular the inside of the motor vehicle window, for example the windscreen of a motor vehicle, is irradiated with radiation from a radiation source. A light emitting diode, for example, may serve as the radiation source, with which radiation outside of the range visible to the human eye is emitted. The radiation may be emitted in pulses, for example. The radiation is directed onto the windowpane at a fixed angle. At least one, in particular exactly one radiation receiver is provided. A photodiode for example may serve as radiation receiver. Depending on the state of the windowpane, that is to say depending on the state of deposits thereon, the radiation emitted by the radiation source is directed back, in particular scatterer or reflected, onto the radiation receiver. In the case of a windowpane covered with moisture, frost, ice or other deposits, the radiation is not only reflected, but also scattered. As a consequence, therefore, less radiation reaches the radiation receiver, which is manifested in lower radiation intensity, since the radiation is reflected back onto a larger surface area. Accordingly, an evaluation of the radiation intensity values detected allows a conclusion to be drawn regarding the state of the deposits on the windowpane. The discrimination between the states of a covered, in particular iced over windscreen and a clear windscreen is crucial for the quality of the detection. The evaluation may be performed out for example by means of an evaluation device such as a computing device. In order to obtain the greatest possible radiation yield for different setting angles and different distances from the windscreen, the sensor apparatus has an optical body with at least one, preferably two, radiation guidance elements. The optical body may be a kind of lens body made from a radiation-permeable material, a transparent plastic, for example. In this context, a radiation guidance element may be assigned to the radiation emitter and a radiation guidance element may be assigned to the radiation receiver. The emitted radiation is directed by the radiation guidance element assigned to the radiation emitter towards a region on the windscreen, so that an optimal and large-area irradiation can be achieved here. The vision cone of the sensor apparatus is influenced by the radiation guidance element. The radiation guidance element assigned to the radiation receiver is designed to ensure that the highest possible radiation intensity, that is to say the greatest possible fraction of the radiation that is returned, in other words radiation reflected or scattered back from the windscreen to the radiation receiver is achieved. In order to achieve maximum variability for the arrangement of the sensor apparatus behind the windscreen, in particular of the distances and setting angles of the sensor apparatus with respect to the windscreen, the radiation guidance elements have segments, in particular segments of stepped construction and arranged one below the other. The stepped segments enable various refractive surfaces to be created facing the sensor elements, that is to say the radiation emitter and the radiation receiver. The radiation guidance elements, in particular the refractive surfaces, may each have a convex curvature, wherein the curvature is formed in the direction of the respective assigned sensor element and slopes away towards the edges of the respective radiation guidance element. The effect of the convex curvature and stepped construction is that, for different distances and different setting angles, not only the widest possible vision cone of the sensor apparatus by the radiation emitter, but also the most complete detection of the light reflected back from the windscreen by the radiation receiver are enabled, and consequently a high radiation yield and accordingly signal yield can be achieved.

In a variant of the invention, one radiation guidance element each is assigned to the radiation emitter and the radiation receiver. A radiation guidance element is assigned to the radiation emitter in order to achieve the optimal irradiation over as large an expanse as possible. The emitted radiation is directed by this guidance element at a region on the windscreen. The radiation guidance element that is assigned to the radiation receiver serves to guide the reflected or scattered radiation towards the radiation receiver.

In a further development of the invention, the radiation guidance elements have a stepped structure, the steps being created by the segments arranged one below the other. The segments of the radiation guidance elements may be arranged one below the other in such manner that a stepped structure of the radiation guidance elements is created. The stepped structure enable a high signal yield to be obtained for various setting angles and for various distances from the sensor apparatus to the windscreen.

In a variant of the invention, the optical body is constructed as a single part, and the optical body embodies the radiation guidance element assigned to the radiation emitter and the radiation guidance element assigned to the radiation receiver. The construction of the optical body as a single part comprising both radiation guidance elements enables a space-saving design of the sensor apparatus and time-efficient installation of the optical body. In a further development of the invention, the radiation guidance elements each have a convex curvature in the direction of the radiation emitter and/or in the direction of the radiation receiver. In particular, each step may have a convex curvature, wherein the curvature extends substantially along the step edges. In particular, the curvature may be designed such that the distance from the radiation guidance element to the respective sensor element is smallest in the middle of the step. The middle region of a radiation guidance element is therefore at a smaller distance from the respective sensor element than the edge regions.

In a further development of the invention, each refractive surface forms a convex curvature substantially along the respective step. The step edges may have substantially the same curvature as the respective refractive surfaces.

In a further development, the sensor apparatus is designed to be arranged in a setting angle range and in a distance range behind the windscreen of a motor vehicle. The stepped arrangement of the segments ensures an optimised signal yield, that is to say an optimised guidance of the radiation reflected back by the windscreen to the radiation receiver.

In a further development of the invention, each radiation guidance element has three steps, the three steps are each designed primarily for guiding the radiation in a section of the angular range between the sensor apparatus and the windscreen and/or in a section of the distance range between the sensor apparatus and the windscreen. The three steps enable a sufficient radiation yield, in other words signal quality for various distances from the sensor apparatus to the windscreen. The steps are preferably arranged one above the other with the sensor apparatus in the installed state, thus resulting in a top, a middle, and a bottom step. The radiation is refracted more by the top, middle or bottom step depending on whether the sensor apparatus is positioned closer to or farther away from the windscreen. The three segments, in other words the three steps, are arranged and designed in such manner that radiation guidance at a certain angle or a certain distance between the sensor apparatus and the windscreen of a motor vehicle is effected mainly by one of the segments arranged one below the other. For example, the angular range may be a range from 10° to 40°, in particular from 15° to 35°. For example, with a medium angular range, radiation is guided mainly through the segment located in the middle.

In a further development of the invention, the refractive surfaces of the three steps have different setting angles with respect to the radiation emitter and/or the radiation receiver. The refractive surfaces of the three steps have different setting angles with respect to the radiation emitter and the radiation receiver, and consequently to the windscreen as well. Because of the different setting angles of the refractive surfaces, each refractive surface is responsible for the main guidance of the radiation in a different angular range or distance range from the sensor apparatus to the windscreen. In this way, it is possible to achieve high radiation intensity and therewith signal yield in a wide angular range and distance range from the sensor apparatus to the windscreen.

In a further development, the optical body has a flat region, and the radiation guidance elements are arranged on the side facing away from the flat region. In particular, an optical body may have two radiation guidance elements, which are arranged on side facing away from the flat region. The flat region may create the exit region and/or the entry region of the radiation, for example. In particular, the flat region may form at least a section of the outer wall of a housing of the sensor apparatus to enable radiation exit and/or radiation entry from the housing.

In a further development of the invention of the sensor apparatus at least one refractive surface has two refractive regions, and the refractive regions are arranged side by side. In this context, a step forms a refractive surface, wherein a refractive surface has two refractive regions, which are arranged side by side. In this situation, the refractive regions transition into each other. With the side-by-side positioning of the refractive regions of a refractive surface, it is possible to achieve good radiation distribution at various angles.

In a further development of the invention, the radiation guidance elements each have an upper boundary surface and a lower boundary surface, a top edge of the upper boundary surface and a bottom edge of the lower boundary surface are arranged substantially parallel to each other, and a projection of the step edge of the bottom step to the plane defined by the flat region and the bottom edge of the lower boundary surface are arranged substantially parallel to each other. A notional projection of the forwardly curved step edge of the bottom step to a plane defined by the flat region is arranged substantially parallel to the bottom edge of the radiation guidance element. At the same time, the bottom step may be designed as a more substantial step than the two steps above it.

In a variant of the invention, a projection of the step edge of the top step to the plane defined by the flat region has a curvature in the direction of the bottom edge relative to the top edge. A notional projection of the forwardly curved step edge of the top step to a plane defined by the flat region is curved towards to the bottom edge of the radiation guidance element in the middle region. Due to the curved course of the step edge between the upper and the middle step, the top step has a more bulbous shape. Consequently, a radiation line is created in a wide angular range between the sensor apparatus and the windscreen.

In a variant of the invention, the sides of the edge of the upper boundary surface and the edge of the lower boundary surface that face away from the created flat region have a curvature in the direction of the sensor elements. The curvatures of the edges of the boundary surfaces substantially predefine the convex curvature of the refractive surfaces.

In a variant of the invention, the optical body has no undercuts. Because there are no undercuts in the shape of the optical body, the optical body can be produced simply and inexpensively, in an injection moulding process, for example.

In a further development of the invention, the refractive regions transition into each other and have no other refraction-inducing edges. The refractive regions of a refractive surface transition into each other in such a way that no edges are formed which might further impair the beam path by scattering or refraction.

In a variant of the invention, the bottom step is more prominent than the top steps. The differing profiles of the various steps makes it possible to obtain very good signal quality, that is to say radiation intensity, with various angles and various distances.

In a variant of the invention, in cross-section the refractive surfaces of the top step and the refractive surfaces of the middle step define an angle wherein the transition region between the refractive surfaces of the top step and the middle step is aligned to face the radiation emitter and/or the radiation receiver, and the bottom step is arranged substantially parallel to the middle step. The notional cross section through a radiation guidance element may pass for example centrally through the upper and lower boundary surfaces, between the respective refractive regions of a refractive surface aligned side by side. In this cross section, the outside edges of the refractive surfaces of the upper step and the outside edge of the middle step run towards each other, so that together they define an angle in the cross section. In the cross section, the outside edges of the refractive surfaces of the bottom and middle step are substantially parallel in a cross section.

The invention further relates to a motor vehicle with a windscreen and with a sensor apparatus according to the invention, wherein the sensor apparatus is arranged behind the windscreen in the interior of the motor vehicle, and wherein the sensor apparatus can be positioned at different distances from the windscreen. Due to the stepped construction of the radiation guidance elements, different distances between the sensor apparatus and the windscreen are possible without any loss of signal quality. The sensor apparatus may thus be installed in various motor vehicle types without further adaptation.

In a variant of the invention, the sensor apparatus can be positioned in various setting angles with respect to the windscreen. The angle between the housing of the sensor apparatus, in particular the flat region of the optical body, and the windscreen is selectable in a range without any loss of signal quality. Consequently, the sensor apparatus can be used in various motor vehicle types without further adaptation.

In the following text, the invention will be explained in greater detail with reference to an exemplary embodiment represented in the drawing. Identical components are denoted with the same reference numerals. Specifically, the diagrammatic representations show:

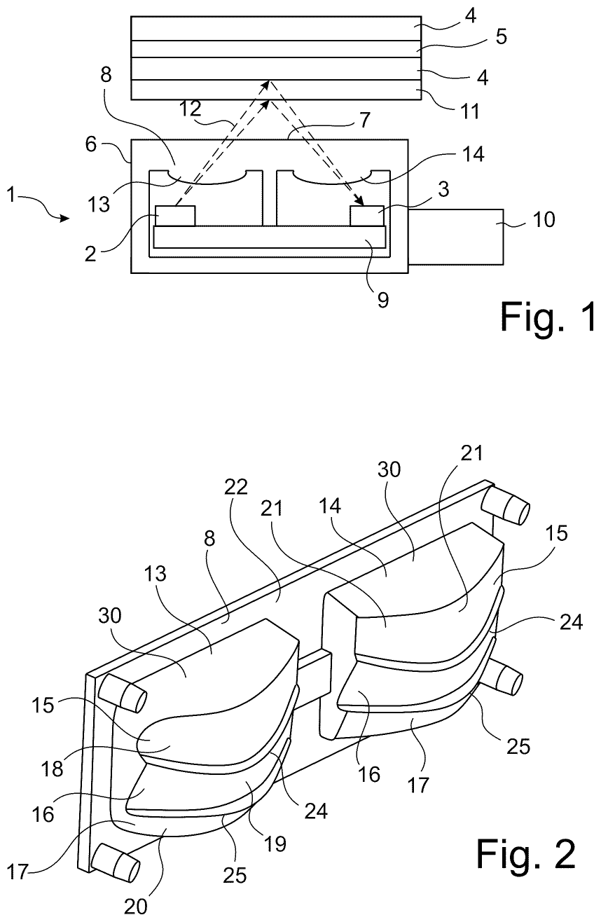

FIG. 1: a cross-sectional view of a sensor apparatus;

FIG. 2: a perspective view of an optical body;

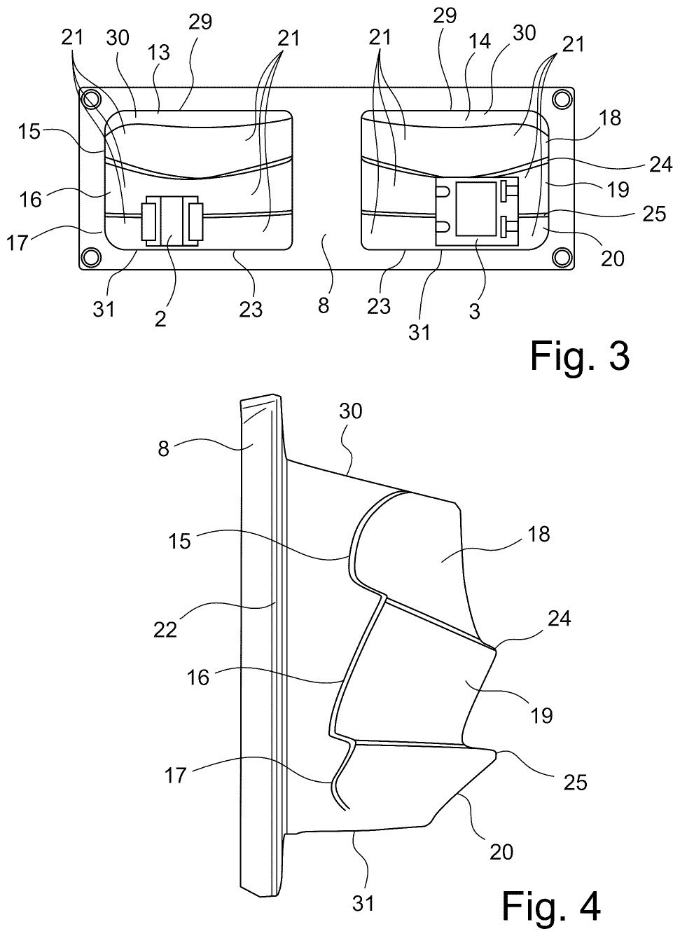

FIG. 3: a front view of an optical body according to FIG. 2;

FIG. 4: a side view of an optical body according to FIG. 2;

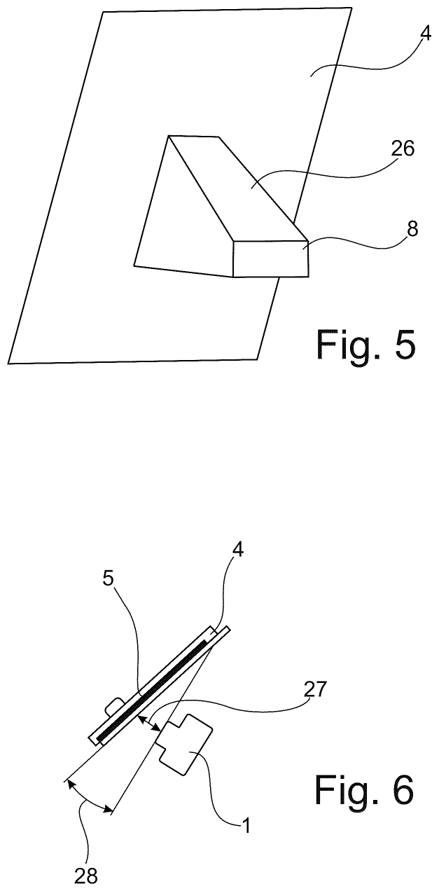

FIG. 5: an optical body according to FIG. 2 in front of a windscreen;

FIG. 6: a sensor apparatus in front of a windscreen; and

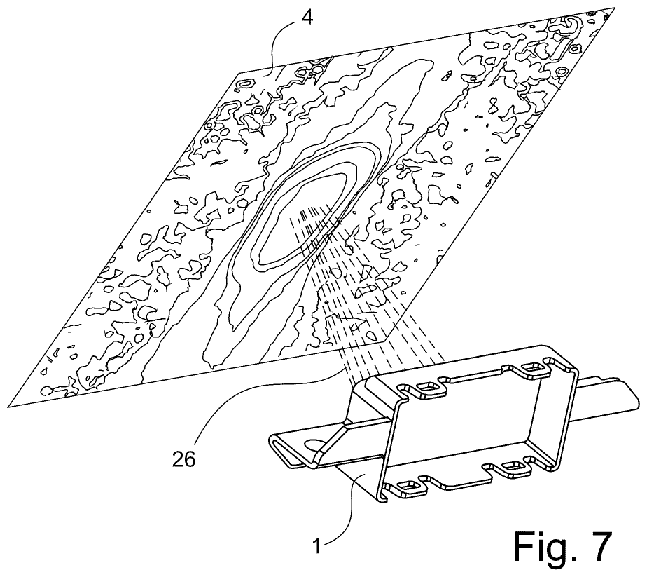

FIG. 7: a sensor apparatus in front of a windscreen with beam path.

FIG. 1 is a cross-sectional representation of a sensor apparatus 1 with a radiation emitter 2 and a radiation receiver 3. The sensor apparatus 1 is arranged in the region of a black print 5 on a windscreen 4. The sensor apparatus 1 has a housing 6 with a radiation-permeable region 7. An optical body 8 is assigned to the radiation emitter 2, which may be embodies as a LED, for example. The optical body 8 guides the radiation emitted by the radiation emitter 2 onto the windscreen 4 at a fixed angle, where in the case of a clear windscreen the radiation is reflected onto the radiation receiver 3 according to the law of reflection. The radiation emitter 2 and the radiation receiver 4 are arranged on a circuit carrier 9. To create a data-conducting connection, with evaluation electronics or similar for example, the housing 6 has an interface 10. In the event of a deposit 11 forming for example as frost, ice or condensation on the windscreen 4, the radiation 12 emitted by the radiation emitter 2 is reflected back from the inside der windscreen 4 not only as reflected radiation but also as scatter radiation. Due to the scattering of the emitted radiation 12, the radiation is reflected back over a wider surface area, thereby reducing the radiation intensity recorded by the radiation receiver 3. The reduced radiation intensity enables detection of a deposit 11 on the windscreen 4.

FIG. 2 represents an optical body 8 with radiation guidance elements 13, 14. The radiation guidance elements 13, 14 are constructed on the side of the optical body 8 facing the sensor elements 2, 3. The radiation guidance element 13 is assigned to the radiation emitter 2, the radiation guidance element is assigned to the radiation receiver 3. The radiation guidance elements 13, 14 each have three stepped segments, that is to say three steps 15, 16, 17, and each have an upper boundary surface 30 and a lower boundary surface 31. The steps are arranged such that there is a top step 15, a middle step 16 and a bottom step 17. The steps each form refractive surfaces 18, 19 and 20. Each refractive surface has two refractive regions 21 arranged side by side. On the side facing away from the radiation guidance element 13, 14, the optical body has a flat region 22, which represents the radiation-permeable region 7 of the housing 6. Steps 15-17 make it possible to adapt the distance between the sensor apparatus 1 and the windscreen 4 and to adapt the setting angle without any loss of signal quality.

FIG. 3 is a top view of a representation of the optical body 8 of FIG. 2. A notional projection of the forwardly curves step edge 25 of the bottom step 17 to a plane defined by the flat region 22 is arranged substantially parallel to the bottom edge 23 of the radiation guidance element 13, 14. In this arrangement, the bottom step 17 may be embodied as a more prominent step than the two steps 15, 16 arranged above it.

A notional projection of the forwardly curved step edge of the top step 15 to a plane defined by the flat region 22 bulges in the middle region towards the bottom edge 23 of the radiation guidance element 13, 14. Due to the curved course of the step edge 24 between the upper 15 and the middle step 16, the top step 15 has a more bulbous shape.

FIG. 4 is a side view of a representation of an optical body 8 according to FIGS. 2 and 3. The bottom step 17 is more pronounced than steps 15 and 16. The outside edge of the refractive surface 20 of the bottom step 17 is arranged substantially parallel to the outside edge of the refractive surface 19 of middle step 16 in cross section. The outside edges of the refractive surfaces 18 and 19 of the top step 15 and of the middle step 16 form an angle in cross section.

In FIG. 5, the optical body 8 of FIGS. 2 to 4 is arranged in front of a windscreen 4. The vision cone 26 of the sensor apparatus 1 is created by the radiation guidance elements 13 and 14.

FIG. 6 shows the alignment of a sensor apparatus 1 in front of a windscreen 4. By virtue of the stepped design of the radiation guidance elements 13 and 14, both the distance 27 and the angle 28 can be changed without any radiation losses.

FIG. 7 represents a sensor apparatus 1 arranged with respect to a windscreen 4. The beam path 26 of the radiation that is emitted by the radiation emitter 2 and reflected back by the windscreen 4 onto the radiation receiver is represented. The design of the optical body 8 enables optimised radiation guidance for a variety of setting angles and distances between the sensor apparatus 1 and the windscreen 4.

1. Sensor apparatus for detecting deposits, in particular water deposits such as moisture deposits and/or ice deposits on a windowpane, in particular on the inside of a motor vehicle window, with a radiation emitter for irradiating the windowpane, and with a radiation receiver for detecting the radiation intensity of the radiation reflected back from the windowpane, and wherein at least one optical body with at least one radiation guidance element is assigned to the radiation emitter and/or the radiation receiver,
wherein
the radiation guidance element has at least two segments each segment has at least one refractive surface, and the refractive surfaces are arranged facing the radiation emitter and/or the radiation receiver.

2. The sensor apparatus according to claim 1, wherein one radiation guidance element each is assigned to the radiation emitter and the radiation receiver.

3. The sensor apparatus according to claim 1, wherein the radiation guidance elements are of stepped construction, wherein the steps are formed by the segments arranged one below the other.

4. The sensor apparatus according to claim 1, wherein the optical body is constructed as a single part and that the optical body forms the radiation guidance element assigned to the radiation emitter and the radiation guidance element assigned to the radiation receiver.

5. The sensor apparatus according to claim 1, wherein at least one radiation guidance element has a convex curvature in the direction of the radiation emitter and/or the radiation receiver.

6. The sensor apparatus according to claim 1, wherein each refractive surface forms a convex curvature substantially along the respective step.

7. The sensor apparatus according to claim 1, wherein the sensor apparatus is designed to be arranged in a setting angle range and in a distance range behind the windscreen of a motor vehicle.

8. The sensor apparatus according to claim 1, wherein the radiation guidance elements each have three steps, that the three steps are each designed primarily for guiding the radiation in a section of the angular range between the sensor apparatus and the windscreen and/or in a section of the distance range between the sensor apparatus and the windscreen.

9. The sensor apparatus according to claim 1, wherein the refractive surfaces of the three steps have different setting angles with respect to the radiation emitter and/or the radiation receiver.

10. The sensor apparatus according to claim 1, wherein the optical body has a flat region and that the radiation guidance elements are arranged on the side of the facing away from the flat region.

11. The sensor apparatus according to claim 1, wherein at least one refractive surface has two refractive regions and that the refractive regions are arranged side by side.

12. The sensor apparatus according to claim 1, wherein the radiation guidance elements each have an upper boundary surface and a lower boundary surface, that a top edge of the upper boundary surface and a bottom edge of the lower boundary surface are arranged substantially parallel to each other, and that a projection of the step edge of the bottom step to the plane defined by the flat region and the bottom edge of the lower boundary surface are arranged substantially parallel to each other.

13. The sensor apparatus according to claim 10, wherein a projection of the step edge of the top step to the plane defined by the flat region has a curvature in the direction of the bottom edge relative to the top edge.

14. The sensor apparatus according to claim 1, wherein the edge of the upper boundary surface and the edge of the lower boundary surface have a curvature in the direction of the sensor elements on the sides thereof facing away from the flat region.

15. The sensor apparatus according to claim 1, wherein the optical body has no undercuts.

16. The sensor apparatus according to claim 1, wherein the refractive regions transition into each other and have no other refraction-inducing edges.

17. The sensor apparatus according to claim 1, wherein the bottom step is more prominent that the top step.

18. The sensor apparatus according to claim 1, wherein in a cross-section the refractive surface of the top step and the refractive surface of the middle step define an angle wherein the transition region between the refractive surfaces of the first step and the middle step is aligned to face the radiation emitter and/or the radiation receiver, and the refractive surface of the bottom step is arranged substantially parallel to the refractive surface of the middle step.

19. The motor vehicle with a windscreen and with a sensor apparatus according to the invention in accordance with claim 1, wherein the sensor apparatus is arranged behind the windscreen in the interior of the motor vehicle, and wherein the sensor apparatus can be positioned at various distances from the windscreen.

20. The motor vehicle according to claim 19, wherein the sensor apparatus can be positioned at various setting angles with respect to the windscreen.
